(19) United States
(12) Patent Application Publication
(10) Pub. No.: US 2015/0068104 A1
(43) Pub. Date: Mar. 12, 2015

(54) INSECT TRAP SYSTEM

(71) Applicant: Amber Mason, Lowry City, MO (US)

(72) Inventor: Amber Mason, Lowry City, MO (US)

(21) Appl. No.: 14/022,479

(22) Filed: Sep. 10, 2013

(51) Int. Cl. A01M 23/02

(52) U.S. Cl. CPC A01M 23/02
USPC 43/107

(57) ABSTRACT

An insect trapping system comprising: a container, where the container includes a threaded top; a threaded top, where the threaded top includes a funnel shape with an opening; and bait within the container to attract insects. In one particular embodiment, the bait includes fruit and the top is threaded around a perimeter.

### BACKGROUND OF THE INVENTION

1. Field of Invention

The present invention relates to an insect trap that is utilized to lure and trap small flying insects.

2. Description of Related Art

Many times households are plagued with flying insects that are a nuisance and bothersome. Some techniques have been developed to kill or repel the insects that may be a problem for a household. Unfortunately many of these techniques may be hazardous because they sometimes require the emission of harmful chemicals into the air and although it may repel the insects the chemicals are not conducive to a healthy environment. In particular, gnats generally are a bothersome pest to many homeowners, and in many cases gnats may accumulate in the kitchen area. Gnats frequently invade the kitchen area due to the frequent food preparation conducted in a kitchen also waste disposal areas can be a particular problem. As stated there are techniques to eliminate gnats or other small insects by using chemical pesticides or repellants to eliminate the gnats but these have some undesired side effects. Consequently there is a need for a simple straightforward solution to trap gnats and dispose of them in a batch fashion.

### SUMMARY OF THE INVENTION

The present invention relates to an insect trapping system comprising: a container, where the container includes a threaded top; a threaded top, where the threaded top includes a funnel shape with an opening; and bait within the container to attract insects. In one particular embodiment, the bait includes fruit and the top is threaded around a perimeter.

### BRIEF DESCRIPTION OF DRAWINGS

FIG. 1 depicts a system for insect trapping in accordance with the present invention.

### DETAILED DESCRIPTION

The present invention relates to a gnat or insect trapping system that utilizes a sealed container with a small opening. The sealed container attracts gnats by the placement of fruit or some other attractive bait within the container. The gnats, once attracted to the bait within the container, descend into an open funnel with a small opening into the container and therefore once inside the container it is difficult for the gnats to escape therefore creating a gnat trap that traps the gnats. The present invention enables the disposal of several gnats within the trap.

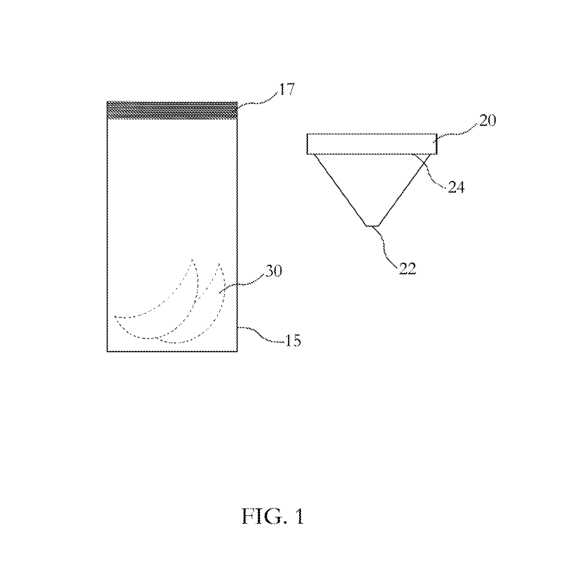

The system for insect trapping in accordance with the present invention includes a cylindrical Container 15 as shown in FIG. 1. The cylindrical container 15 includes a threaded Top 17. The threaded top 17 allows for the placement of a funnel-shaped top that twists onto the Container 15. The funnel-shaped Top 20 is also depicted in FIG. 1. The funnel-shaped Top 20 includes a perimeter 24 that fits onto the threaded top 17 of the container 15. The perimeter 24 screws onto the threaded top 17 and then allows for the partial sealing of the Container 15. An Opening 22 is shown at the bottom of the funnel Top 20. Once put in place if provides an opening large enough for the entry of insects or gnats into the closed Container 15. Fruit 30 or other bait may be provided within the container 15 in order to attract insects within the container 15. Once the system is assembled insects will be attracted to the bait within the container 15 and then sealed within the Container 15 for disposal as needed. In one particular embodiment, the Container 15 and Top 20 are made of disposable material, which may already include a gnat attracting substance. Further the Top 20 may vary in size so as to fit various sized openings.

In one particular embodiment, this cylindrical container may be about 5½ inches in height and 2½ inches in width. The lid or top has a funnel shape so that the insect is attracted to the small opening provided at the tip of the funnel. Further the trap uses bait such as fruit that is non-toxic and allows for the attraction of gnats within the container.

What is claimed is:

1. An insect trapping system comprising:
a. a container, where the container includes a threaded top;
b. a threaded top, where the threaded top includes a funnel shape with an opening; and
c. bait within the container to attract insects.

2. The insect trapping system according to claim 1, where the bait includes fruit.

3. The insect trapping system according to claim 1, where the top is threaded around a perimeter.
